(19) United States
(12) Patent Application Publication
(10) Pub. No.: US 2023/0376867 A1
(43) Pub. Date: Nov. 23, 2023

(54) METHOD AND APPARATUS FOR ASSIGNING REMOTE OPERATION ON VEHICLE TO REMOTE OPERATOR, AND NON-TRANSITORY COMPUTERREADABLE STORAGE MEDIUM

(71) Applicant: TOYOTA JIDOSHA KABUSHIKI KAISHA, Toyota-shi Aichi-ken (JP)

(72) Inventors: Hiromitsu URANO, Numazu-shi Shizuoka-ken (JP); Takefumi GOTO, Gotemba-shi Shizuoka-ken (JP); Masahiro HARADA, Ebina-shi Kanagawa-ken (JP); Hiromitsu KOBAYASHI, Nisshin-shi Aichi-ken (JP)

(73) Assignee: TOYOTA JIDOSHA KABUSHIKI KAISHA, Toyota-shi Aichi-ken (JP)

(21) Appl. No.: 18/132,652

(22) Filed: Apr. 10, 2023

(30) Foreign Application Priority Data
May 17, 2022 (JP) 2022-081063

(51) Int. Cl. G06Q 10/0631; G05D 1/00

(52) U.S. Cl. CPC G06Q 10/063114; G05D 1/0027; G05D 1/0022; G05D 2201/0213

(57) ABSTRACT

The method of the present disclosure is a method for assigning a remote operation on a vehicle to a remote operator by a computer. According to the method of the present disclosure, a requested remote operation is classified into a first type of operation in which only one operation can be assigned to one remote operator at a time and a second type of operation in which a plurality of operations can be assigned to one operator at a time. When the requested remote operation is the first type of operation, the requested remote operation is assigned to an idle remote operator. When the requested remote operation is the second type of operation, the requested remote operation is assigned to an active remote operator already engaged in the second type of operation.

### CROSS-REFERENCE TO RELATED APPLICATION

The present application claims priority under 35 U.S.C. § 119 to Japanese Patent Application No. 2022-081063, filed May 17, 2022, the disclosure of which is incorporated herein by reference in their entirety.

### BACKGROUND

### Field

The present disclosure relates to a technique for assigning a remote operation on a vehicle to a remote operator.

### Background Art

Various prior arts are known for providing remote operations to a vehicle, such as driving, directing, assisting, or monitoring. JP2021-144732A discloses a prior art based on the premise that one remote operator is in charge of a plurality of vehicles. In the prior art, when remote control is required for one of a plurality of vehicles for which a remote operator is in charge, autonomous driving for avoiding the remote control is instructed for the other vehicles.

If the remote control for one vehicle is completed in a short time, no particular problem may occur. However, in the case where the remote operator has to work for a long time, the above-described prior art is disadvantageous. This is because if the remote operator is engaged in the remote control of one vehicle for a long time, a situation may occur in which some remote operation is required in another vehicle during that time. Even if a remote operation request for another vehicle is received during the remote control, the remote operator cannot handle the request. Therefore, in order to handle remote operations for a large number of vehicles without delay, a large number of remote operators corresponding to the number of vehicles must be prepared. In order to provide a mobility service at a low cost, it is an important issue to reduce the labor cost by suppressing the required number of remote operators.

In addition to JP2021-144732A, JP2018-142265A and JP2019-185279A can be exemplified as documents showing the technical level of the technical field related to the present disclosure.

### SUMMARY

The present disclosure has been made in view of the above-described problems. An object of the present disclosure is to provide a technique that enables remote operations on vehicles to be handled by as few remote operators as possible.

The present disclosure provides a method for assigning a remote operation on a vehicle to a remote operator by a computer.

The method of the present disclosure comprises the following steps. The first step is a step of classifying a requested remote operation into a first type of operation in which only one operation can be assigned to one remote operator at a time and a second type of operation in which a plurality of operations can be assigned to one operator at a time. The second step is a step of assigning the requested remote operation to an idle remote operator when the requested remote operation is the first type of operation, The third step is a step of assigning the requested remote operation to an active remote operator who is already engaged in the second type of operation when the requested remote operation is the second type of operation.

According to the method of the present disclosure, the remote operation corresponding to the first type of operation and the remote operation corresponding to the second type of operation are assigned to different remote operators. In particular, the remote operation corresponding to the second type of operation is preferentially assigned to the operator already engaged in the second type of operation. This increases the average number of operations handled per unit time per remote operator and reduces the number of remote operators required.

The second type of operation includes a plurality of types of remote operation having different contents. When the remote operator handles a plurality of remote operations corresponding to the second type of operation, the load on the remote operator depends on the content of each remote operation. Therefore, the assigning the requested remote operation to the remote operator already engaged in the second type of operation in the third step may include selecting a remote operator to which the requested remote operation is assigned from among a plurality of remote operators already engaged in the second type of operation based on the content of the second type of operation engaged by each of the plurality of remote operators and the content of the requested remote operation.

Even though the remote operator can handle a plurality of remote operations at a time if they fall under the second type of operation, there is a limit to the number of remote operations that can be handled by one remote operator. Thus, the assigning the requested remote operation to the remote operator already engaged in the second type of operation in the third step may include assigning the requested remote operation to a remote operator engaged in less than an upper limit number of operations belonging to the second type of operation. However, when the requested remote operation is the second type of operation and there is no remote operator engaged in less than the upper limit number of operations belonging to the second type of operation, the requested remote operation may be assigned to an idle remote operator.

It is assumed that every remote operator is assigned at least one remote operation and there is no idle remote operator. When the remote operation requested in such a situation is the first type of operation, the second type of operation in which some of the active remote operators already engaged in the second type of operation are engaged may be reassigned to remaining active remote operators Then, the requested remote operation may be assigned to the remote operator who becomes idle by reassigning the second type of operation.

The present disclosure provides an apparatus for assigning a remote operation on a vehicle to a remote operator.

The apparatus of the present disclosure includes at least one processor and a program memory storing a plurality of executable instructions. The plurality of instructions is configured to cause the at least one processor to execute the following processes. The first process is to classify a requested remote operation into a first type of operation in which only one operation can be assigned to one remote operator at a time and a second type of operation in which a plurality of operations can be assigned to one operator at a time. The second process is to assign the requested remote operation to an idle remote operator when the requested remote operation is the first type of operation. The third process is to assign the requested remote operation to a remote operator already engaged in the second type of operation when the requested remote operation is the second type of operation.

The present disclosure provides a program for assigning a remote operation on a vehicle to a remote operator.

The program according to the present disclosure is configured to cause a computer to execute the following processes. The first process is to classify a requested remote operation into a first type of operation in which only one operation can be assigned to one remote operator at a time and a second type of operation in which a plurality of operations can be assigned to one operator at a time. The second process is to assign the requested remote operation to an idle remote operator when the requested remote operation is the first type of operation. The third process is to assign the requested remote operation to a remote operator already engaged in the second type of operation when the requested remote operation is the second type of operation. The program according to the present disclosure may be recorded in a non-transitory computer-readable recording medium.

As described above, according to the method, the apparatus, and the program of the present disclosure, by increasing the average number of operations handled per unit time per one remote operator, it is possible to handle the remote operation on the vehicle by the minimum number of remote operators.

### BRIEF DESCRIPTION OF THE DRAWINGS

FIG. 1 is a diagram illustrating a basic rule of a remote operation assignment method according to an embodiment of the present disclosure.

FIG. 2 is a diagram illustrating a basic rule of a remote operation assignment method according to an embodiment of the present disclosure.

FIG. 3 is a diagram illustrating a basic rule of a remote operation assignment method according to an embodiment of the present disclosure.

FIG. 4 is a diagram illustrating an exception rule of a remote operation assignment method according to an embodiment of the present disclosure.

FIG. 5 is a diagram illustrating an exception rule of a remote operation assignment method according to an embodiment of the present disclosure.

FIG. 6 is a block diagram illustrating an example of a configuration of a remote operation assignment apparatus according to an embodiment of the present disclosure.

FIG. 7 is a block diagram illustrating an example of a hardware configuration of a remote operation assignment apparatus according to an embodiment of the present disclosure.

FIG. 8 is a flowchart showing an example of processing executed by the remote operation apparatus configured as shown in FIG. 6.

### DETAILED DESCRIPTION

### 1. Remote Operation Assignment Method

### 1-1. Overview

The primary objective of performing remote operations on vehicles is to reduce labor costs. Conventionally, provision of a mobility services has been based on the premise that one driver is always in one vehicle. However, if one remote operator can manage a plurality of vehicles using autonomous driving technology or remote communication technology, reduction in labor costs can be achieved, leading to provision of inexpensive mobility services.

However, there is a possibility that only one remote operator can perform remote operation at a time. For example, an autonomous driving vehicle whose autonomous driving level is level 4 or less needs to be instructed, assisted or driven by a remote operator depending on its performance or function. In order to provide a safe and secure mobility service using such an autonomous vehicle, it is considered that the number of vehicles on which a remote operator performs a remote operation at a time should be only one. Therefore, in order to provide a mobility service using autonomous driving of level 4 or less, a number of remote operators corresponding to the number of vehicles are required.

On the other hand, the remote operation on the vehicle also includes monitoring operation such as in-vehicle monitoring for an unmanned vehicle. In the case of monitoring operation for preventing trouble in a vehicle, the number of vehicles that one remote operator can remotely monitor at a time is not always one. In normal times when no trouble occurs, the remote operator can monitor a plurality of vehicles at a time. That is, the remote operation includes a remote operation in which only one operation can be assigned to one remote operator at a time, such as remote assistance for an autonomous driving vehicle, and a remote operation in which a plurality of operations can be assigned to one remote operator at a time, such as remote monitoring. In the present application, the former remote operation is referred to as a first type of operation or a one-to-one operation, and the latter remote operation is referred to as a second type of operation or a one-to-N operation (N means an arbitrary natural number).

In the remote operation assignment method according to the present embodiment, the above-described two types of remote operation are distinguished from each other, and the method of assigning remote operators is changed depending on the type of the remote operation. Specifically, if the newly requested remote operation is a one-to-one operation, the remote operation is assigned to an idle remote operator. However, if the newly requested remote operation is a one-to-N operation, the remote operation is preferentially assigned to a remote operator already engaged in another one-to-N operation. This makes it possible to provide a safe and secure mobility service by one remote operator taking charge of one vehicle, and to reduce labor costs by one remote operator managing a plurality of vehicles.

The following is an example of a typical remote operation.

### (A) Remote Driving

Remote driving is an operation in which a remote operator operates a steering, a pedal, a shift lever, a winker, and the like from a cockpit simulating a driver's seat at a remote place.

### (B) Remote Instruction

Remote instruction is an operation in which a remote operator issues an instruction to a vehicle from a remote place based on information from in-vehicle sensors. For example, when the remote operator views camera images transmitted from the vehicle and gives an instruction “go straight along the road”, the vehicle autonomously travels along the road while observing the traffic rule. In addition, when the autonomous driving system cannot recognize a traffic signal due to backlight, the remote operator observes camera images to determine the color of the lighting lamp of the traffic signal and updates the recognition information of the traffic signal included in the autonomous driving system.

### (C) Remote Assistance

Remote assistance is an operation in which a remote operator assists a vehicle from a remote place based on information of from in-vehicle sensors. For example, when the ego-vehicle and a vehicle coming from the opposite lane arrive at an intersection with no traffic signal at substantially the same time and turn right to each other, it may be difficult to autonomously determine which vehicle should start first. In such a case, the remote operator makes a determination based on experience and knowledge, such as “the driver of the oncoming vehicle is about to start” or “I can start the ego-vehicle prior to the oncoming vehicle because the driver of the oncoming vehicle is giving a signal to go first by gesturing,” based on images from a vehicle-mounted camera, and notifies the vehicle of a driving action according to the determination.

### (D) Remote Monitoring

Remote monitoring is an operation in which a remote operator views camera images from a vehicle-mounted camera, monitors whether there is an abnormality, a trouble, or a danger, and takes a countermeasure such as calling attention or contacting the police or a fire station as necessary.

### (E) Remote Calling

Remote calling is an operation in which a remote operator responds to a user by using a communication device such as an interphone mounted on a vehicle or a call device. For example, it is conceivable to answer questions about the destination of the bus, the charge, etc.

With respect to remote driving, remote instruction and remote assistance among the above five types of remote operations, it is believed that a single remote operator should be engaged in only one operation at a time in order to safely perform the operation. Therefore, remote driving, remote instruction, and remote assistance are classified into one-to-one operation (first type of operation). On the other hand, regarding remote monitoring, when the urgency is low and there is no abnormality at the present time, it is considered that there is no problem even if one remote operator performs a plurality of monitoring operations at a time. Therefore, remote monitoring is classified into one-to-N operation (second type of operation). With regard to remote calling, the urgency may be low as in remote monitoring, but it is difficult to answer two calls at a time. Thus, remote calling may be a one-to-N operation or a one-to-one operation.

Note that the vehicle to which the remote operation assignment method according to the present embodiment is applied is not limited to an autonomous driving vehicle. Vehicles requiring remote operation may be manually driven vehicles, privately owned vehicles, or mobility-as-a-service vehicles. Vehicles to be remotely monitored include, for example, a manual driving bus and an autonomous driving bus.

### 1-2. Specific Example

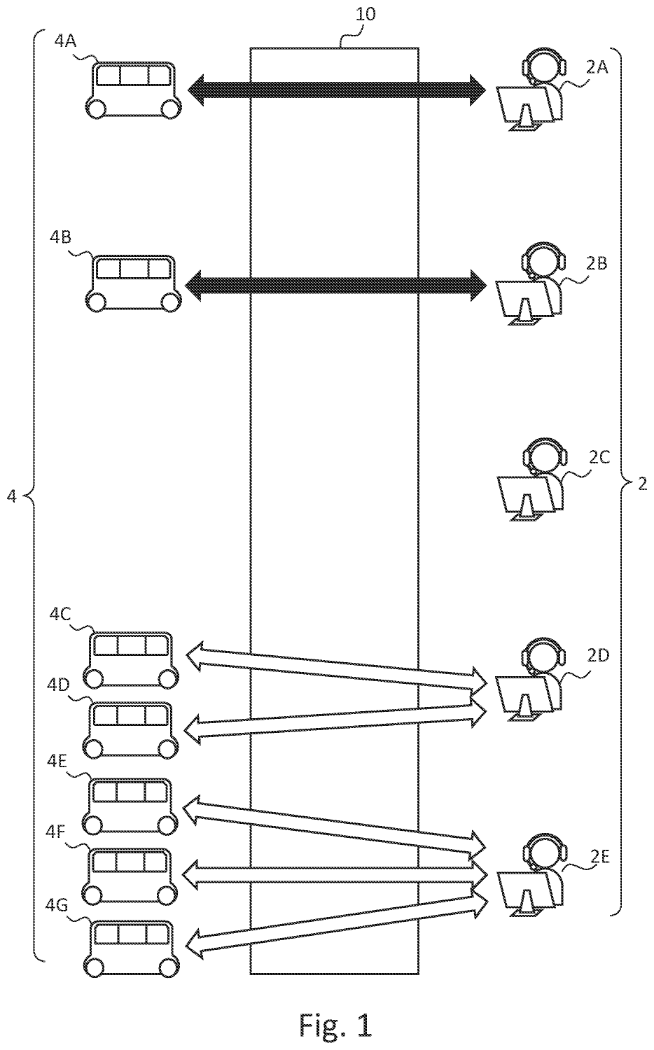

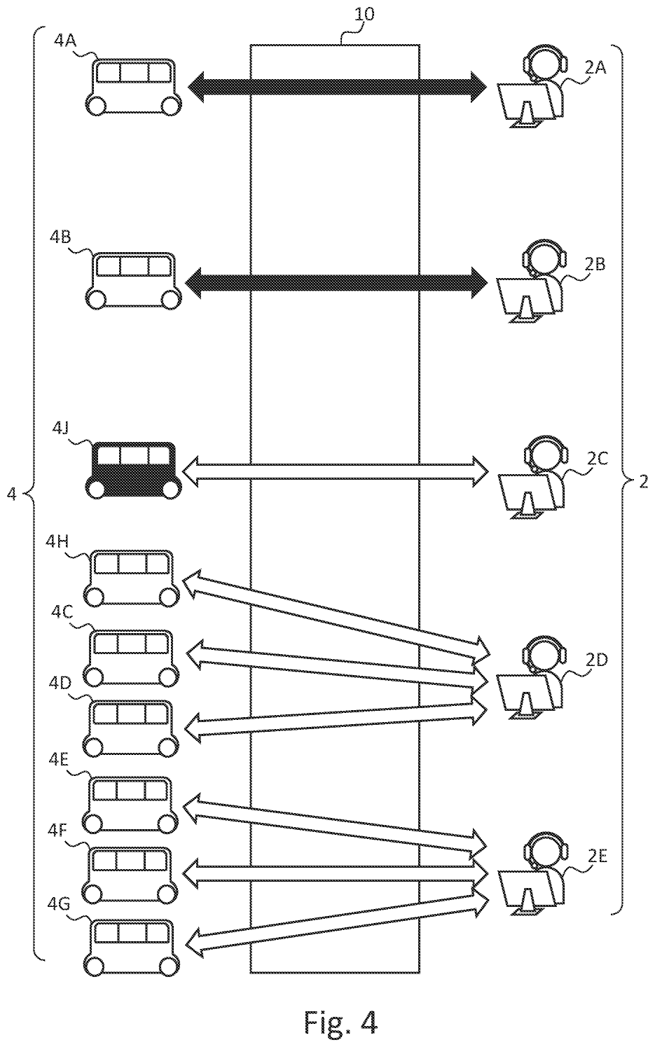

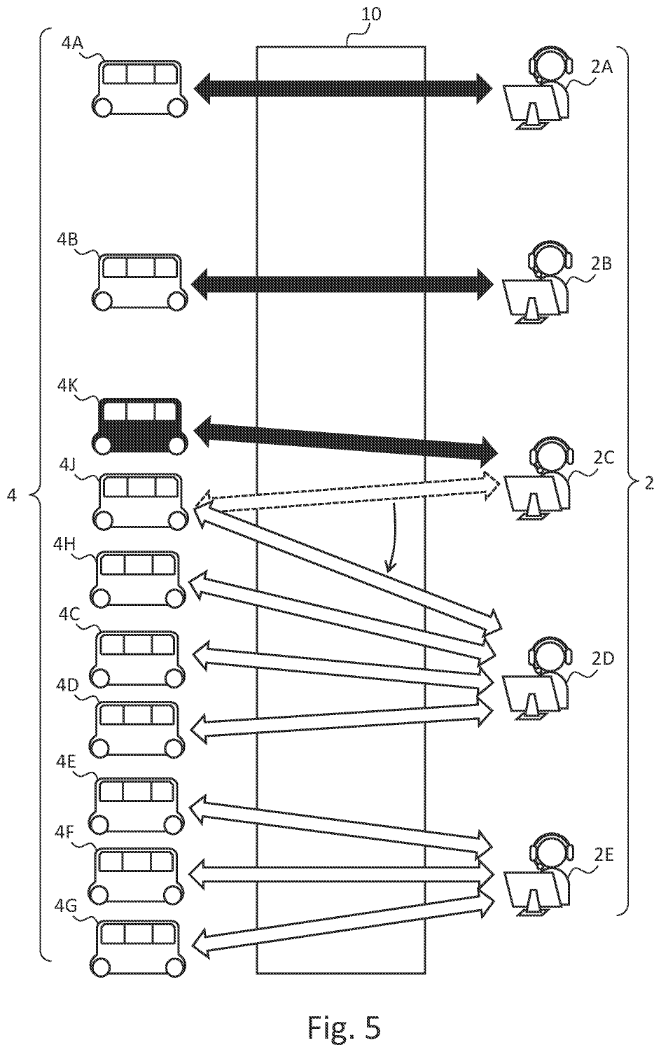

Hereinafter, a specific example of a remote operation assignment method will be described with reference to FIGS. 1 to 5. In detail, FIGS. 1 to 3 are diagrams illustrating basic rules of the remote operation assignment method, and FIGS. 4 and 5 are diagrams illustrating exception rules of the remote operation assignment method.

FIG. 1 illustrates an example in which remote operations on a plurality of vehicles 4 is performed by a plurality of remote operators 2. The type of vehicles 4 is not limited as long as they are vehicles requiring remote operation. Vehicles 4 includes a vehicle that requests only one-to-one operation, a vehicle that requests only one-to-N operation, and a vehicle that requests both one-to-one operation and one-to-N operation. When individual vehicles are distinguished from each other, identifiers for identifying each vehicle such as vehicle 4A, 4B, 4C, 4D, 4E, 4F, and 4G are used.

Remote operators 2 perform remote operations from a cockpit at a remote place. When individual remote operators are distinguished from each other, identifiers for identifying the respective remote operators such as remote operators 2A, 2B, 2C, 2D, and 2E are used. The cockpit and the vehicle 4 are connected by a communication network including a wireless communication system. The cockpit is constructed to accommodate remote operations such as remote driving, remote instruction, remote assistance, remote monitoring, and remote calling.

The assignment of remote operations is performed by a remote operation assignment apparatus 10. The function and hardware configuration of the remote operation assignment apparatus 10 will be described later. In FIG. 1, the vehicles 4 and the remote operators 2 are connected by arrow lines passing through the remote operation assignment apparatus 10. Each arrow line indicates a remote operation determined by the remote operation assignment apparatus 10. Remote operations belonging to one-to-one operation are indicated by black arrow lines and remote operations belonging to one-to-N operation are indicated by white arrow lines.

In the example shown in FIG. 1, the one-to-one operation on the vehicle 4A is handled by the remote operator 2A, and the one-to-one operation on the vehicle 4B is handled by the remote operator 2B. The one-to-N operation on the vehicle 4C and the one-to-N operation on the vehicle 4D are handled at a time by the remote operator 2D. In addition, the one-to-N operation on the vehicle 4E, the one-to-N operation on the vehicle 4F, and the one-to-N operation on the vehicle 4G are handled at a time by the remote operator 2E at a time. The remote operator 2C is an idle remote operator.

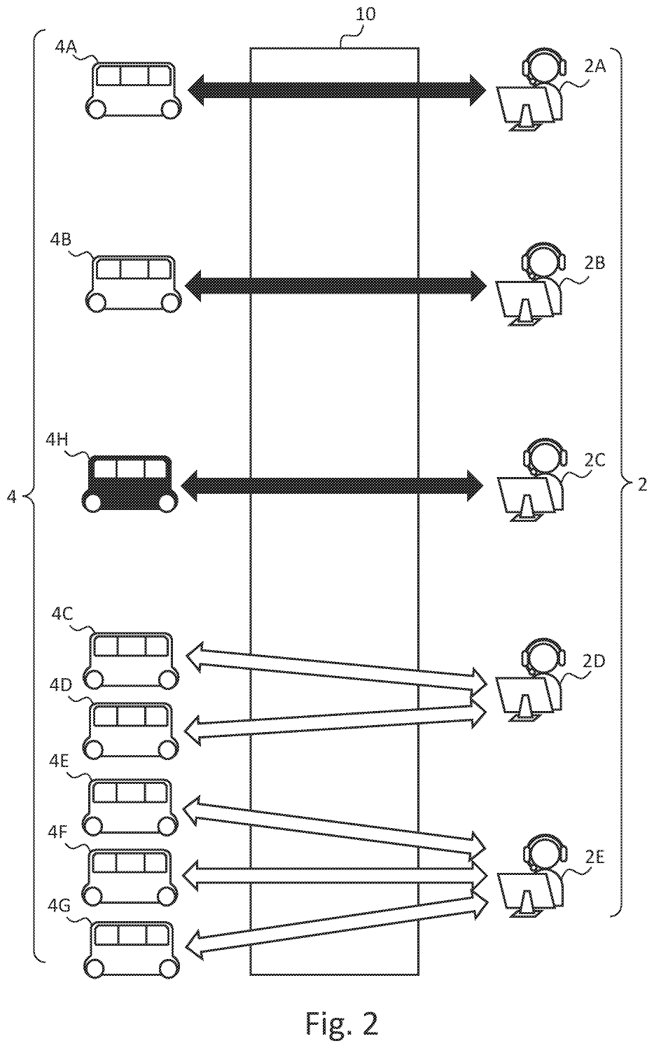

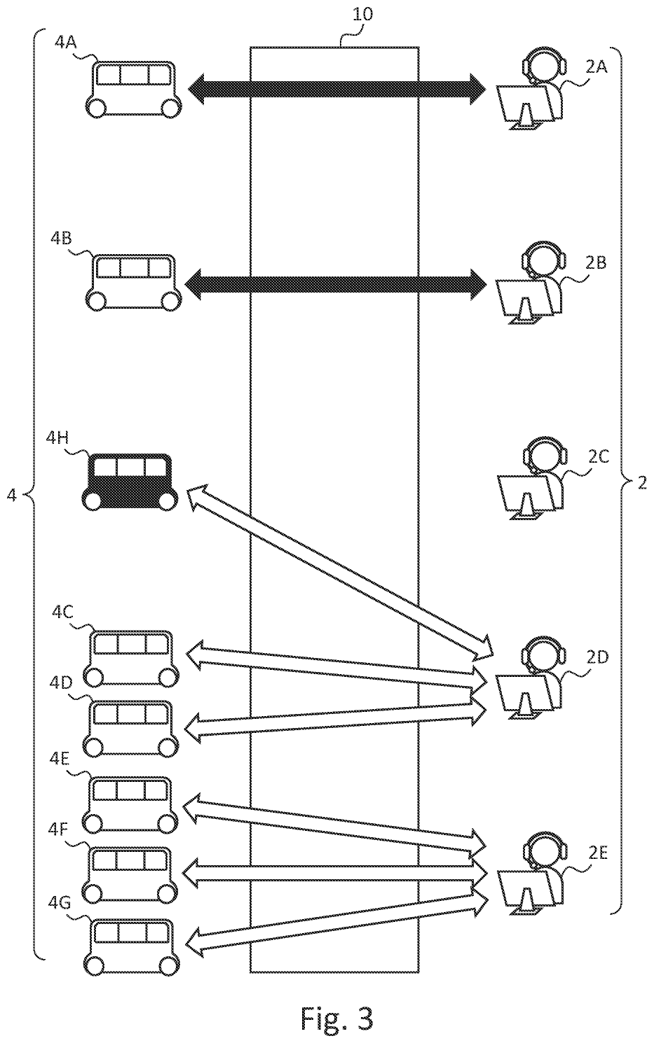

In the example shown in FIG. 2, a one-to-one operation on the vehicle 4H is newly requested. The remote operation assignment apparatus 10 assigns the one-to-one operation on the vehicle 4H to the idle remote operator 2C according to the basic rule of the remote operation assignment method. On the other hand, in the example shown in FIG. 3, a one-to-N operation on the vehicle 4H is newly requested. The remote operation assignment apparatus 10 assigns the newly requested one-to-N operation not to the idle remote operator 2C but to the remote operator 2D already engaged in another one-to-N operation according to the basic rule of the remote operation assignment method. This allows the remote operator 2C to remain idle. Note that in the present disclosure, a remote operator engaged in one-to-N operation rather than one-to-one operation is referred to as an active remote operator.

In the example shown in FIG. 4, after the one-to-N operation is requested from the vehicle 4H, a one-to-N operation is newly requested from the vehicle 4J. According to the basic rule of the remote operation assignment method, the one-to-N operation on the vehicle 4J is assigned to a remote operator already engaged in another one-to-N operation. However, the remote operator 2D and the remote operator 2E have already been assigned three one-to-N operations, respectively. In this specific example, the upper limit number of one-to-N operations that can be handled at a time by one remote operator 2 is three. Thus, the one-to-N operation on the vehicle 4J cannot be assigned to either the remote operator 2D or the remote operator 2E. In this case, the remote operation assignment apparatus 10 assigns the newly requested one-to-N operation to the idle remote operator 2C according to the exception rule of the remote operation assignment method.

Note that the upper limit number of three is merely an example. One method of determining the upper limit number is to determine the upper limit number for each remote operator in accordance with the proficiency level in remote operation. For example, in the case of monitoring operation by a remote camera, the upper limit number may be decreased (for example, two) for a less experienced remote operator, and the upper limit number may be increased (for example, five) for an experienced remote operator.

Further, a method may be considered in which the upper limit number is regarded as operation available points, and a plurality of operations can be performed at a time up to the operation available points. For example, when the operation point of the remote monitoring is one, a remote operator having operation available points of five can engage in five operations of remote monitoring at a time. However, when the operation points of remote calling are three and the current operation points of a remote operator with operation available points of five are two, the remote operator cannot be assigned a remote calling. That is, the remote operator to which a newly requested one-to-N operation is to be assigned is determined based on the contents of the one-to-N operation that each remote operator is already engaged in and the contents of the newly requested one-to-N operation.

The operation point may be fixedly assigned to each type of remote operation or may be dynamically changed depending on the situation. For example, in the case of remote monitoring, if the number of passengers included in a camera image is five or less, the operation may be regarded as a simple operation and the operation point may be set to a small value (for example, one). If the number of passengers is greater than five, the operation point may be set to a large value (for example, two) assuming that more attention should be paid because of a complicated situation.

In the example shown in FIG. 5, after the one-to-N operation is requested from the vehicle 4J, a one-to-one operation is newly requested from the vehicle 4K. According to the basic rule of the remote operation assignment method, the one-to-one operation on the vehicle 4K is assigned to an idle remote operator. However, when the one-to-N operation on the vehicle 4J is assigned to the remote operator 2C, all the remote operators 2 are filled and there is no idle remote operator.

Since one-to-one operation is a remote operation having a larger influence on the traffic flow than one-to-N operation, the remote operation assignment apparatus 10 allows the number of the one-to-N operation assignments to exceed the upper limit number according to the exception rule of the remote operation assignment method, and forcibly creates an idle remote operator. In the example shown in FIG. 5, the one-to-N operation that remote operator 2C is engaged in is reassigned to the remote operator 2D. Then, the one-to-one operation on the vehicle 4K is assigned to the idle remote operator 2C. The remote operator to be made idle by the re-assignment of the one-to-N operation may be the remote operator 2D or the remote operator 2E.

By assigning remote operations in the above-described manner, it is possible to realize the optimum arrangement of remote operators such that one-to-N operations are performed by a small number of remote operators. As a result, it is possible to manage a large number of vehicles 4 at a low labor cost, and it is possible to provide a mobility service at a low cost.

### 2. Remote Operation Assignment Apparatus

### 2-1. Configuration of Remote Operation Assignment Apparatus

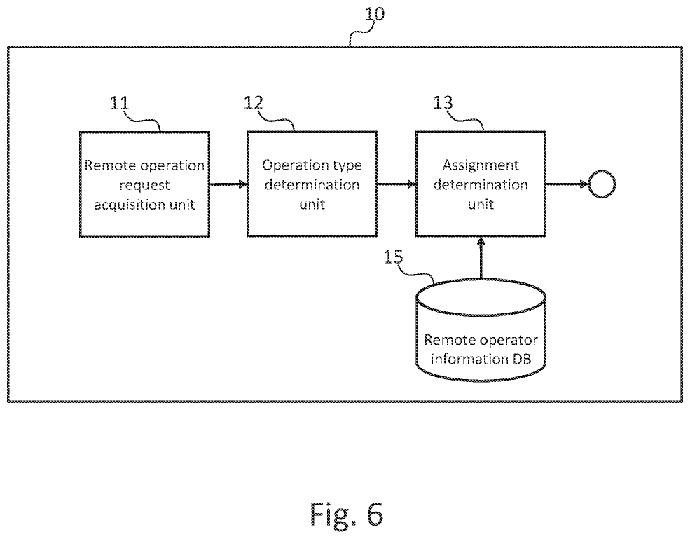

FIG. 6 is a block diagram illustrating an example of the configuration of the remote operation assignment apparatus 10. The remote operation assignment apparatus 10 includes a remote operation request acquisition unit 11, an operation type determination unit 12, an assignment determination unit 13, and a remote operator information database 15.

The remote operation request acquisition unit 11 is configured to acquire a request for a remote operation on the vehicle 4. The request source of the remote operation and the request items differ depending on the type of the remote operation.

### (A) Remote Driving

The request source of the remote operation is the vehicle 4. The request item is to remotely drive the vehicle 4. For example, a driver monitor provided in the vehicle 4 detects a driver's drowsy or intoxicated driving, and requests a remote operator to perform remote driving. The remote operator performs operation according to the situation, such as moving the vehicle 4 to a safe place.

### (B) Remote Instruction, and

### (C) Remote Assistance

The request source of the remote operation is the autonomous driving system of the vehicle 4. The request items are to determine the surrounding situation and to give an instruction about the driving behavior or to support the driving behavior. For example, in a vehicle in which the autonomous driving level is equal to or lower than level 4, the environmental condition of the vehicle 4 may deviate from the condition in which autonomous traveling can be performed when the vehicle 4 falls in a complicated situation in which autonomous determination cannot be performed, or a color of a traffic light cannot be recognized due to backlight. In such a case, the remote operator is informed of the peripheral situation photographed by a vehicle-mounted camera, and is asked to determine whether or not the vehicle can be started and to give an instruction or assistance. The vehicle 4 travels according to the instruction or assistance from the remote operator.

### (D) Remote Monitoring.

The request source of the remote operation is the vehicle 4 or a server that monitors the vehicle 4. The request item is visual check by a vehicle-mounted camera. For example, when an abnormality (a person stands up during traveling, the vehicle 4 does not depart even after a scheduled time, or the like) is detected by a vehicle-mounted camera, the vehicle 4 notifies the business operator of the occurrence of the abnormality. Alternatively, the server checks the vehicle state at predetermined time intervals, requesting the remote operator to visually check the vehicle state using a vehicle-mounted camera every time a predetermined time elapses.

### (E) Remote Calling

The request source of the remote operation is the vehicle 4 or the infrastructure equipment of the mobility-as-a-service company. The request item is to respond to the user. For example, when there is a call through an interphone installed in an infrastructure such as a mobility-as-a-service vehicle or a bus station, a remote operator responds to the call.

The request for remote operation may be accompanied by information for specifying the vehicle that requests the remote operation. The information for specifying the vehicle includes, for example, information such as a vehicle management ID, location information, and a vehicle state (speed, autonomous driving or manual driving, and driver state).

The operation type determination unit 12 is configured to determine whether the requested remote operation is a one-to-one operation or a one-to-N operation. One example of a determination method is to decide in advance whether each of remote driving, remote instruction, remote assistance, remote monitoring, and remote calling corresponds to a one-to-one operation or a one-to-N operation. For example, it may be decided that remote monitoring is a one-to-N operation and other remote operations are one-to-one operations.

Another example of the determination method is to dynamically determine whether the requested remote operation is a one-to-one operation or a one-to-N operation according to urgency. For example, the urgency is lower when there is no person in the vicinity of the vehicle than when there is a person in the vicinity of the vehicle. Therefore, the former may be determined as one-to-one operation, and the latter may be determined as one-to-N operation. In addition, when an interphone is pressed but a person's face is not captured in a camera, it can be determined that an erroneous operation has occurred. Since the urgency in this case is low, it may be determined that the requested remote operation is a one-to-N operation. When the color of a traffic light cannot be confirmed due to backlight, it may be determined that the traffic light is a red light from the movement of another vehicle. Also in this case, since the urgency is low, it may be determined that the requested remote operation is a one-to-N operation.

The remote operator information database (DB) 15 is a database storing information on remote operators 2. The remote operator information database 15 is configured to know whether or not each of the remote operators is engaged in a remote operation, and if engaged in the remote operation, whether the remote operator is engaged in a one-to-one operation or a one-to-N operation. The remote operator information database 15 is also configured to know the number of operations and the contents of each operation if each of the remote operators is engaged in the one-to-N operation.

The assignment determination unit 13 is configured to determine the remote operator 2 to which the requested remote operation is assigned based on the type of the remote operation determined by the operation type determination unit 12 and the remote operator information registered in the remote operator information database 15. According to the basic rule of the remote operation assignment method, when the requested remote operation is a one-to-one operation, an idle remote operator is determined as the assignment destination. When the requested remote operation is a one-to-N operation, it is preferentially assigned to the remote operator already engaged in the one-to-N operation. However, when the number of one-to-N operations in which the remote operator is engaged reaches the upper limit number of simultaneous operations, a new one-to-N operation is assigned to an idle remote operator.

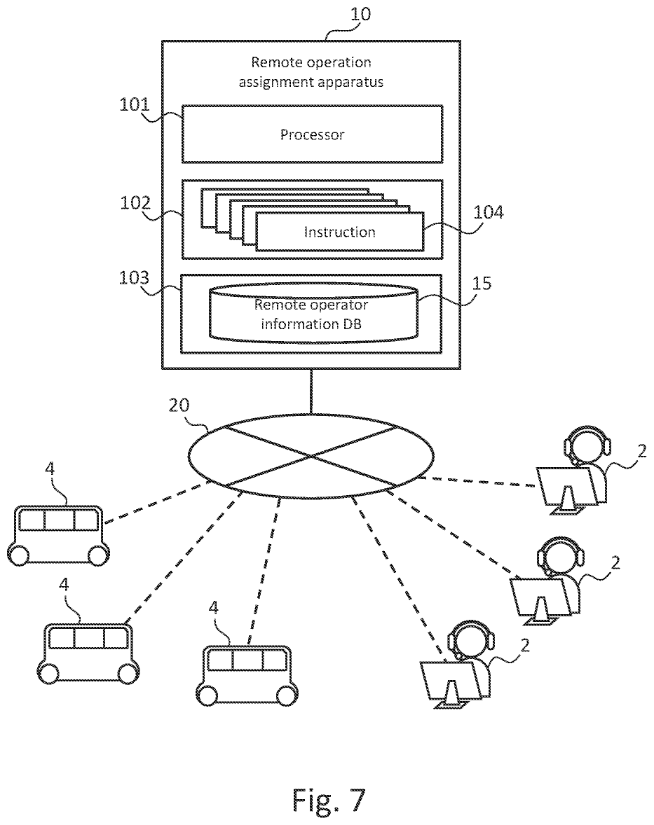

The remote operation request acquisition unit 11, the operation type determination unit 12, the assignment determination unit 13, and the remote operator information database 15 can be realized as a function of one computer or a function of a system including a plurality of computers. For example, when the remote operation assignment apparatus 10 is a computer, these functions can be realized by the hardware configuration shown in FIG. 7. FIG. 7 is a block diagram illustrating an example of a hardware configuration of the remote operation assignment apparatus 10.

The remote operation assignment apparatus 10 is connected to vehicles 4 and remote operators 2 via a communication network 20 including, for example, a mobile communication system. The remote operation assignment apparatus 10 includes at least one processor 101 (hereinafter simply referred to as the processor 101), a program memory 102, and a data storage 103. The processor 101 is coupled to the program memory 102 and the data storage 103. The program memory 102 may be a non-transitory storage medium that stores executable instructions 104. The data storage 103 is, for example, a flash memory, a solid-state drive (SSD), or a hard disk drive (HDD), and the remote operator information database 15 is constructed therein. The plurality of instructions 104 include instructions for causing the remote operation assignment apparatus 10 to function as the remote operation request acquisition unit 11, the operation type determination unit 12, the assignment determination unit 13, and the remote operator information database 15.

### 2-2. Processing by Remote Operation Assignment Apparatus

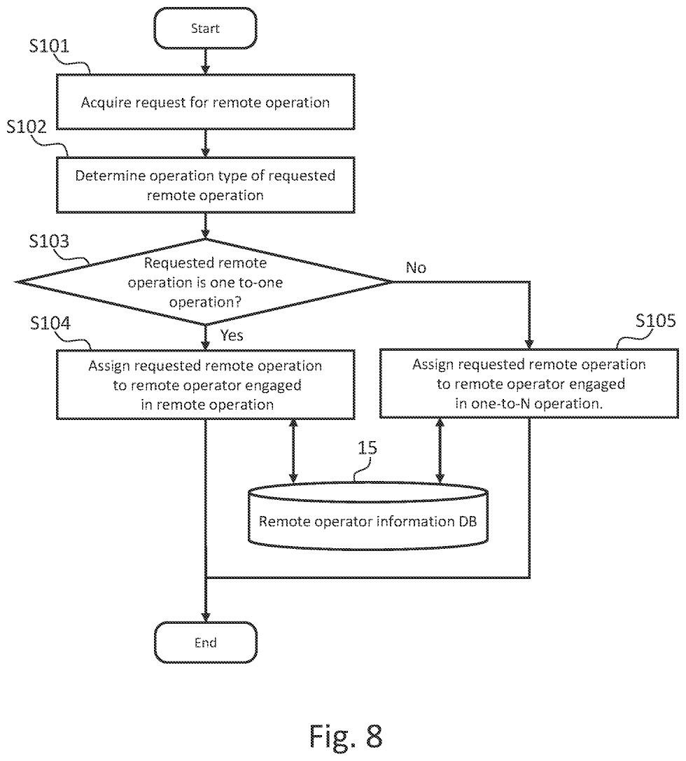

Next, processing executed by the remote operation assignment apparatus 10 configured as described above will be described with reference to FIG. 8. FIG. 8 is a flowchart showing an example of processing executed by the remote operation assignment apparatus 10. However, the following flowchart shows the basic rule of the remote operation assignment method, and the exception rule is omitted.

In step S101, the remote operation request acquiring unit 11 acquires a request for a remote operation. The request source of the remote operation and the request items differ depending on the type of the remote operation. The types of remote operations include remote driving, remote instruction, remote assistance, remote monitoring, and remote calling.

In step S102, the operation type determination unit 12 determines the type of the requested remote operation. The operation type determination unit 12 determines whether the requested remote operation is a one-to-one operation or a one-to-N operation.

Subsequently, in step S103, the result of determination by the operation type determination unit 12 is confirmed by the assignment determination unit 13. When the requested remote operation is a one-to-one operation, the assignment determination unit 13 performs the process of step S104. When the requested remote operation is a one-to-N operation, the assignment determination unit 13 performs the process of step S105.

In step S104, the remote operator information database 15 is searched by the assignment determination unit 13, and information on remote operators who are not engaged in a remote operation is obtained as a search result. An assignment determination unit 13 assigns the requested one-to-one operation to a remote operator who is not engaged in a remote operation.

In step S105, the assignment determination unit 13 searches the remote operator information database 15 to obtain information on remote operators already engaged in a one-to-N operation as a search result. The assignment determination unit 13 assigns the requested one-to-N operation to a remote operator already engaged in a one-to-N operation.

### 3. Other Embodiments

In FIGS. 1 to 5, the operation requested by one vehicle is illustrated as “one one-to-one operation” or “one one-to-N operation”. However, this is only one example of an embodiment of the method and apparatus of the present disclosure. That is, “a plurality of one-to-one operations” or “a plurality of one-to-N operations” may be requested from one vehicle, or “one-to-one operation” and “one-to-N operation” may be requested at a time. For example, assuming a case where an inquiry from a passenger is issued from the inside of a vehicle traveling under a remote instruction, this means that two one-to-one operations are requested at a time. Further, for example, assuming a case where remote monitoring in the vicinity of a door of a certain vehicle and remote monitoring in the vehicle interior are requested at a time, this means that two one-to-N operations are requested at a time.

What is claimed is:

1. A method for assigning a remote operation on a vehicle to a remote operator by a computer, comprising:
classifying a requested remote operation into a first type of operation in which only one operation can be assigned to one remote operator at a time and a second type of operation in which a plurality of operations can be assigned to one operator at a time;
assigning the requested remote operation to an idle remote operator when the requested remote operation is the first type of operation; and
assigning the requested remote operation to an active remote operator already engaged in the second type of operation when the requested remote operation is the second type of operation.

2. The method according to claim 1, wherein the assigning the requested remote operation to the active remote operator comprises selecting an active remote operator to assign the requested remote operation from among a plurality of active remote operators based on a content of the second type of operation each active remote operator is engaged in and a content of the requested remote operation.

3. The method according to claim 1, wherein the assigning the requested remote operation to the active remote operator comprises assigning the requested remote operation to an active remote operator engaged in less than an upper limit number of operations belonging to the second type of operation.

4. The method according to claim 3, further comprising assigning the requested remote operation to an idle remote operator when the requested remote operation is the second type of operation and no active remote operator is engaged in less than the upper limit number of operations belonging to the second type of operation.

5. The method according to claim 1, further comprising:
when the requested remote operation is the first type of operation and there is no idle remote operator, reassigning the second type of operation in which some of a plurality of active remote operators are engaged to remaining active remote operators; and
assigning the requested remote operation to a remote operator that becomes idle due to the reassigning of the second type of operation.

6. An apparatus for assigning a remote operation on a vehicle to a remote operator, comprising:
at least one processor; and
a program memory storing a plurality of executable instructions configured to cause the at least one processor to:
classify a requested remote operation into a first type of operation in which only one operation can be assigned to one remote operator at a time and a second type of operation in which a plurality of operations can be assigned to one operator at a time;
assign the requested remote operation to an idle remote operator when the requested remote operation is the first type of operation; and
assign the requested remote operation to an active remote operator already engaged in the second type of operation when the requested remote operation is the second type of operation.

7. The apparatus according to claim 6, wherein the assigning the requested remote operation to the active remote operator comprises selecting an active remote operator to assign the requested remote operation from among a plurality of active remote operators based on a content of the second type of operation each active remote operator is engaged in and a content of the requested remote operation.

8. The apparatus according to claim 6, wherein the assigning the requested remote operation to the active remote operator comprises assigning the requested remote operation to an active remote operator engaged in less than an upper limit number of operations belonging to the second type of operation.

9. The apparatus according to claim 8, wherein the instructions are configured to further cause the at least one processor to assign the requested remote operation to an idle remote operator when the requested remote operation is the second type of operation and no active remote operator is engaged in less than the upper limit number of operations belonging to the second type of operation.

10. The apparatus according to claim 6, wherein the instructions are configured to further cause the at least one processor to:
when the requested remote operation is the first type of operation and there is no idle remote operator, reassign the second type of operation in which some of a plurality of active remote operators are engaged to remaining active remote operators; and
assign the requested remote operation to a remote operator that becomes idle due to the reassigning of the second type of operation.

11. A non-transitory computer-readable storage medium storing a program for assigning a remote operation on a vehicle to a remote operator, the program being configured to cause a computer to:
classify a requested remote operation into a first type of operation in which only one operation can be assigned to one remote operator at a time and a second type of operation in which a plurality of operations can be assigned to one operator at a time;
assign the requested remote operation to an idle remote operator when the requested remote operation is the first type of operation; and
assign the requested remote operation to an active remote operator already engaged in the second type of operation when the requested remote operation is the second type of operation.

12. The non-transitory computer-readable storage medium according to claim 11, wherein the assigning the requested remote operation to the active remote operator comprises selecting an active remote operator to assign the requested remote operation from among a plurality of active remote operators based on a content of the second type of operation each active remote operator is engaged in and a content of the requested remote operation.

13. The non-transitory computer-readable storage medium according to claim 11, wherein the assigning the requested remote operation to the active remote operator comprises assigning the requested remote operation to an active remote operator engaged in less than an upper limit number of operations belonging to the second type of operation.

14. The non-transitory computer-readable storage medium according to claim 13, wherein the program is configured to further cause the computer to assign the requested remote operation to an idle remote operator when the requested remote operation is the second type of operation and no active remote operator is engaged in less than the upper limit number of operations belonging to the second type of operation.

15. The non-transitory computer-readable storage medium according to claim 11, wherein the program is configured to further cause the computer to:
when the requested remote operation is the first type of operation and there is no idle remote operator, reassign the second type of operation in which some of a plurality of active remote operators are engaged to remaining active remote operators; and
assign the requested remote operation to a remote operator that becomes idle due to the reassigning of the second type of operation.
